(19) United States
(12) Patent Application Publication
(10) Pub. No.: US 2004/0210504 A1
(43) Pub. Date: Oct. 21, 2004

(54) Options automated trading system (OATS) and method of options trading

(76) Inventor: Will Rutman, Morganville, NJ (US)

Correspondence Address: Jean-Marc Zimmerman, Esq., 226 St. Paul Street, WESTFIELD, NJ, 07202, US

(21) Appl. No.: 10/192,882

(22) Filed: Jul. 5, 2002

(51) Int. Cl. G06F 17/60

(52) U.S. Cl. 705/37

(57) ABSTRACT

An online automated trading system that automatically executes a trade of an option order based solely on the price of the underlying security. When executing the trade, the system acts as a proxy on behalf of the trader in executing the trade via an online brokerage account established through an online brokerage provider. Furthermore to execute a trade, pre-configured information regarding a number, sequence and content of web pages to effectuate a trade with the online brokerage provider and information regarding at least one online brokerage account with the online brokerage provider are used to effectuate a trade online through the World-Wide-Web.

### FIELD OF THE INVENTION

The present invention relates to e-trading systems and methods and, more particularly, to an options automated trading system (OATS) that tracks current market prices for given United States (US) equity securities, and when a particular price condition defined on such a security is fulfilled, automatically executes a corresponding predefined option order pertaining to the given security.

### BACKGROUND OF THE INVENTION

Currently, when trading equity securities, the trader places a limit order based on the price of the option itself. Since the trader is cognizant of the potential profit of trading options, the trader is better able to take advantage of trigger conditions to make profits. However, the current restriction in placing limit orders frequently subjects a trader to losses or missed gains due to various inefficiencies which may lead to a delayed or missed execution of that order.

The equity options traders are faced with several problems which can diminish gains. For example, one problem the traders face is the inability to submit an order, whether by phone or by electronic means, to buy or sell various types of equity options based on a price condition defined on the underlying security. This problem stems from a lack of systems capable of executing such orders automatically, at the market price of the equity option based solely on the underlying securities.

In view of the forgoing, there is a continuing need for a system capable of executing such orders automatically, at the market price of the equity option based solely on conditions related to the underlying securities without human intervention or interaction.

As will be seen more fully below, the present invention is substantially different in structure, methodology and approach from that of the prior e-trading systems and methods.

### SUMMARY OF THE INVENTION

The present invention contemplates an options automated trading system (OATS) and method of automated options trading that tracks current market prices for given United States (US) equity securities, and when a particular price condition defined on such a security is fulfilled, automatically executes a corresponding predefined option order pertaining to the given security. Accordingly, execution is based solely on the price of the underlying security.

The OATS is intended primarily to provide the unattended, automatic execution of option trades based on price conditions related to each specific equity security underlying the specific option at issue in a trade transaction.

The present invention further contemplates an OATS that acts as a proxy on behalf of the trader in executing the trade via online brokerage providers having accounts established for the trader. When executing a trade, the OATS programmatically performs those operations that would result if the trader accessed the online brokerage account of the provider via a web browser.

The above and other objects of the present invention will become apparent from the drawings, the description given herein and the appended claims.

### BRIEF DESCRIPTION OF THE DRAWINGS

FIG. 1 illustrates the general diagram of the OATS in accordance with the present invention.

FIG. 2 illustrates the network relationships of the OATS in accordance with the present invention.

FIG. 3A illustrates an exemplary data file for market data feed in accordance with the present invention.

FIG. 3B illustrates and exemplary market data event record in accordance with the present invention.

FIG. 4 illustrates an exemplary data file for an online brokerage account in accordance with the present invention.

FIG. 5 illustrates an overview of the modes of operation of the OATS application in accordance with the present invention.

FIG. 6 illustrates a pending order list and an order record in accordance with the present invention.

FIG. 7 illustrates an exemplary order entry graphical user interface (GUI) in accordance with the present invention.

FIG. 8 illustrates a general flowchart of the OATS trading logic in accordance with the present invention.

### DETAILED DESCRIPTION OF THE INVENTION

### Definitions, Acronyms and Abbreviations

AMEX—American Stock Exchange.

Ask price, inside—the lowest price advertised at which there are sellers of a stock.

Bid price, inside—the highest price advertised at which there are buyers for a stock.

CBOE—Chicago Board Options Exchange.

CSS—Cascading Style Sheets, a standard promulgated by W3C.

Data import—reading in data from external files which may have been generated by other applications.

Data export—writing data to external files which may be used by other applications.

Date, expiration—The end of the life of an options or futures contract.

Derivative—security derivative—a monetary instrument derived from one or more underlying securities, whose price is determined by some formula based on the underlying securities.

Equity—a particular type of security which assigns to the holder ownership in a share of the profits of the issuer.

Execution—of order—(1) the processing and fulfillment of a trading order; (2) the record of information describing (1).

GUI—Graphical User Interface.

HTML—Hyper Text Markup Language particularly version 4.0x.

Icon—a graphical symbol, typically a part of a graphical user interface, which denotes a particular function or access to particular information.

IP—Internet Protocol—version 4 unless otherwise specified.

LEAPS options—Long-term Equity Anticipation Securities long-term options that don't expire for at least 9 months.

Market data—(1) information received from specialized service provider regarding the status of securities trading on a market exchange; (2) specific information on securities including but not limited to securities trading status, trading volume, bid and ask prices, time and sales.

Market data feed—a service which provides a computer-accessible source of market data, typically delivered in a serial stream of information packets each containing the latest information on happenings in the securities market.

Market data provider—a commercial vendor who operates a market data feed service.

Market price—the price at which a security or security derivative will trade on a market exchange may alternately denote inside bid or inside ask price, depending on context.

NASD—National Association of Securities Dealers.

NASDAQ—National Association of Securities Dealers Automated Quote system.

NYSE—New York Stock Exchange.

NULL—a distinguished value indicating the contents of a particular data field are empty or do not apply to certain processing.

OATS—Options Automated Trading System.

Option—(1) the right, but not the obligation, to buy or sell a stock (or other security) for a specified price on or before a specific date; (2) a security carrying such rights as in (1), which can be traded on an exchange.

Option premium—the cost of an option.

Option class—all options of one type (put or call) that have the same underlying stock.

Option series—all the options in one class with the same strike price.

Option, put—The buyer of a put option has purchased the right to sell 100 shares of the underlying stock at the contracted exercise price.

Option, call—The buyer of an equity call option has purchased the right to buy 100 shares of the underlying stock at the stated exercise price.

Options, listed—Listed options are those options traded on the U.S. exchanges Listed options come in two forms: CALL options and PUT options Exchanges include: CBOE, Philadelphia Stock Exchange, American Stock Exchange, Pacific Stock Exchange.

Order—(1) a description of a particular trade that a trader would like to execute; (2) the record containing all data fields describing (1) (3) a binding request to execute a trade.

Order, limit—an order to buy or sell stock with a price limit attached to it.

Order, stop loss—An order placed with a broker to buy or sell when a certain price is reached. It is designed to limit an investor's loss on a security position, sometimes called stop market order.

Order, market—An order placed with a broker to buy or sell at whatever price the market will set.

Order, GTC—Good 'Till Canceled An order which will remain in a broker's system indefinitely until it is filled or canceled by the party who submitted it.

Order, daily—Also Day Order. An order which will remain in a broker's system only until the end of trading on the day on which the order was placed. It will either be filled before the end of the day, or deleted from the system at the end of the day.

PC—Personal Computer.

PCX—Pacific Stock Exchange.

PHLX—Philadelphia Stock Exchange.

Price—of a security—unless otherwise specified, in USD ($), accurate to two decimal places.

Price condition—a condition predicated on a price, with relationship equals (=), greater than (>) or less than (<).

Security—a monetary instrument, such as a stock, which may be purchased or sold, which carries specific rights and/or obligations assigned to the holder by the issuer.

SEC—Securities and Exchange Commission.

Socket(s)—A popular programming interface for TCP/IP networking applications.

Std.—Standard

Stock—synonym for equity security.

Strike price—The stated price per share for which underlying stock may be purchased (for a call) or sold (for a put) by the option holder upon exercise of the option contract.

Symbol—of U.S. equity, stock.

TCP—Transmission Control Protocol—also short for TCP/IP.

TCP/IP—Transmission Control Protocol over Internet Protocol.

Trade—A synonym of order. A particular buy or sell transaction, execution or order.

Transaction, trade—(1) a business exchange involving a security between two or more parties; (2) a record of all data describing (1).

UDP—User Datagram Protocol.

U.S. equity security—an equity security issued by a U.S. corporation and trading in U.S. stock markets.

W3C—World Wide Web Consortium.

XML—eXtensible Markup Language.

### Overview of the OATS

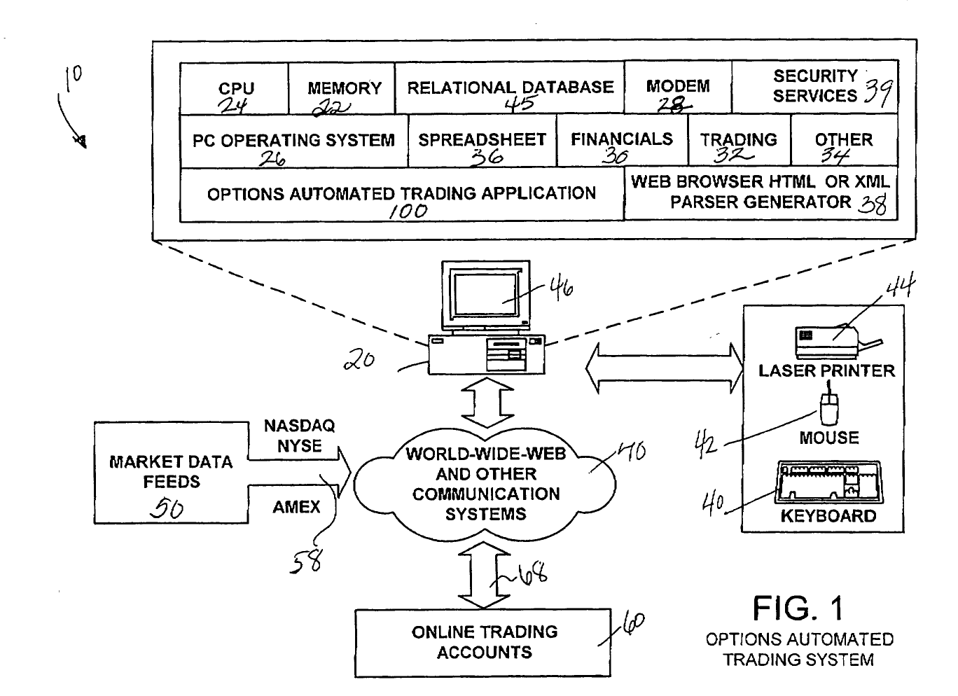

With reference to FIG. 1, the options automated trading system 10 is shown. In general, an OATS application 100 is implemented on a computing device 20 to provide a tool for traders who wish to trade Listed Equity Options or the like based on conditions defined on the underlying security price. This tool provides traders with a means to guarantee execution of a trade at the market price on the underlying security price of an option, rather than accepting the current status quo, which involves placing a limit order based on the price of the option itself.

Accordingly, since the trader is cognizant of the potential profit of trading options, the trader is better able to take advantage of trigger conditions to make profits which they might have missed without such a tool. Moreover, the trader is no longer hampered by the current restriction of limit orders which frequently subjects a trader to losses or missed gains due to various inefficiencies which may lead to a delayed or missed execution of that order.

The OATS 10 provides a means for the trader to receive and monitor any market data, real-time or otherwise, enter trade orders, and execute such orders wherein execution of the order is automatic and requires no intervention or interaction by the trader.

### OATS

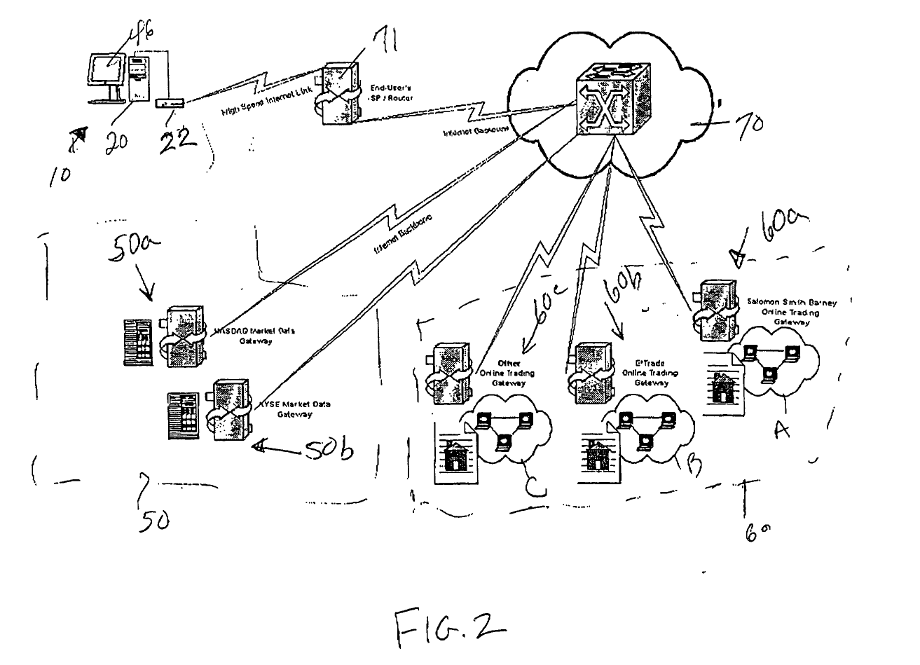

Referring still to FIGS. 1 and 2, OATS application 100 functions in concert with several other software components and systems. Among these are one or more market data feeds 50 on lines 58; one or more online trading accounts 60, via remote online brokerage providers, accessible through the world wide web 70 on lines 68; a relational database system 45; and a computing device 20, such as a personal computer, which processes the OATS application 100.

The computing device 20 includes memory 22, CPU 24 and operating system 26. The computing device 20 further includes a modem 28 to link the computing device 20 to the serving ISP 71 (FIG. 2). The computing device 20 also supports a keyboard 40, a mouse 42, printer 44 and display 46. Preferably, the OATS application 100 supports a completely mouse-less mode of operation wherein the trader can execute operations (such as, without limitation, Resume and Suspend, described in detail below) more quickly through memorized use of special keys or key-combinations on the keyboard 40. Since there are numerous possible key-combinations, to describe such key-combinations is prohibitive.

The OATS application 100 is configured with a variety of information, which is derived either directly from the trader, or through a combination of data from its market data feeds 50 on line 58 and the input of the trader. Accordingly, the OATS application 100 interfaces with the following systems: Market Data Feed 50 (Including NYSE market feed and NASDAQ/AMEX market feed); and, Online Trading Account 60 (via WWW). To communicate with such systems, OATS 10 includes a Web Browser and/or HTML Parser/Generator 38; PC Operating System 26 (Including: File System, GUI and TCP/IP Communications Services); and Security Services 39 (including Encryption, Authentication, and Identification).

Since the, OATS 10 interfaces with communications services, specifically to make various types of connections and lookup services related to the Internet and World Wide Web 70, the computing device 20 may employ an Ethernet card (NOT SHOWN), although there are less common alternatives such as Token Ring. A 10 mbps Ethernet NIC is sufficient for the OATS 10, but 100 mbps capability can offer superior performance during times of heavy market activity. Most modern Ethernet NICs support both 10 and 100 mbps operation (hence 10/100-base-T).

### Market Data Feed

The computing device 20 is connected to one or more real-time market data feeds 50, which provide pricing and status information on the securities the trader is interested in trading options for, as well as general market status. The market data feeds 50 are delivered over a high-speed Internet connection between the computing device 20 and the trader's ISP 71 (ISDN speed or greater) and therefore are constructed of TCP and/or UDP data packets (which, in turn, are constructed on IP packet format—the lingua franca of the Internet).

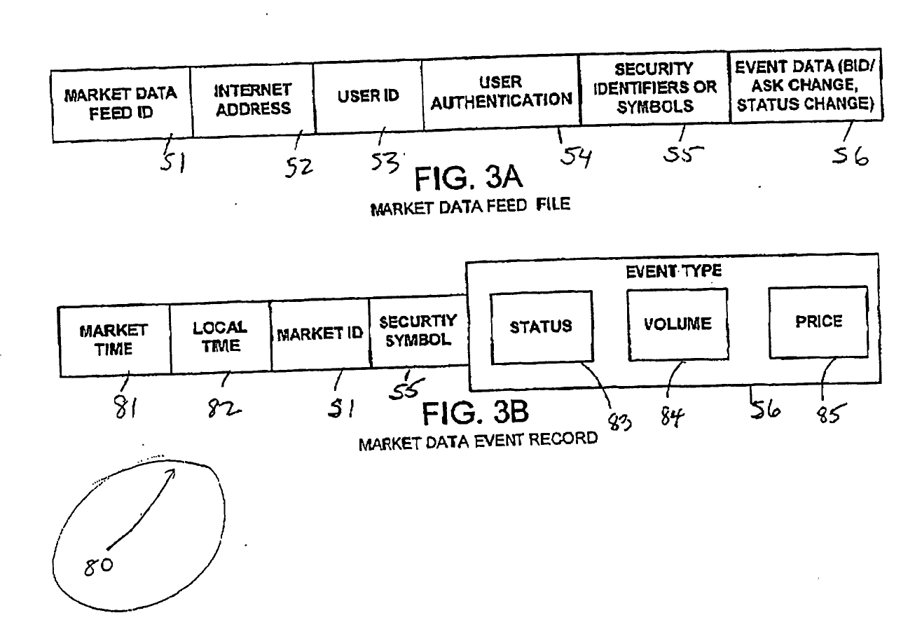

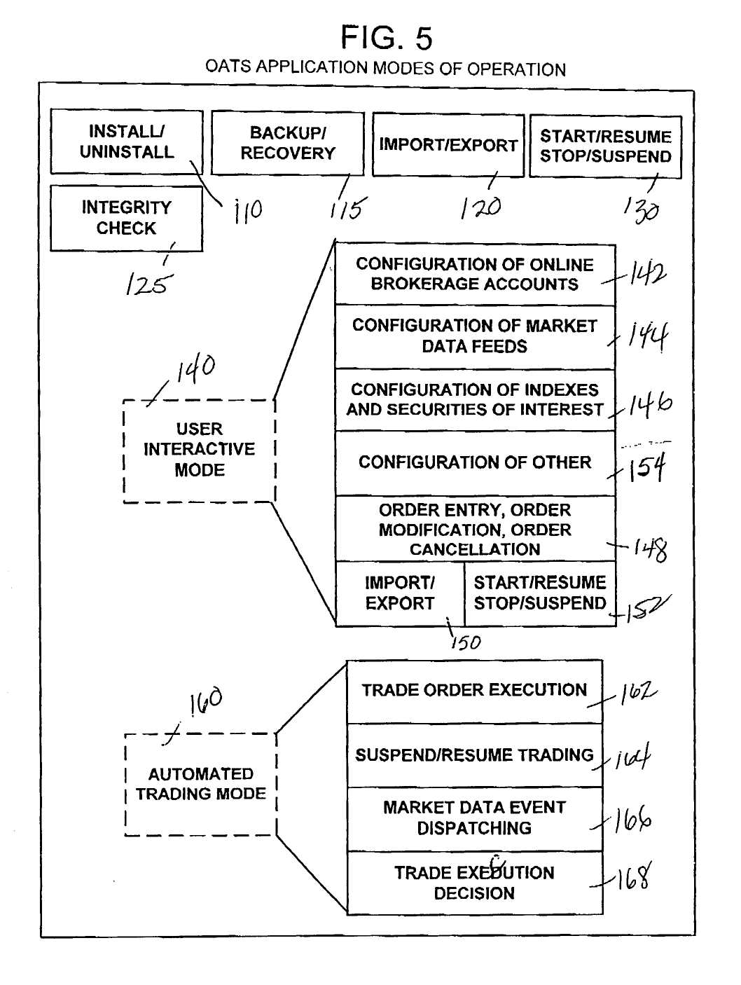

Referring also to FIG. 3A, the OATS application 100 accepts and stores all such information as part of its configuration for each market data feed 50 it will access including: Market Data Feed identification 51, Internet address 52 (typically including a hostname and/or Internet address and port number); user identification 53; user authentication 54; specific data of interest (including one or more security identifiers (symbols) 55; and event types 56 (such as bid/ask change and status change). The market data feed configuration is setup during the configuration mode 144 of the market data feed (FIG. 5). As can be appreciated, a configure GUI (NOT SHOWN) for the market data feed file would have the necessary data entry fields to enter the above information. Some of the data entry fields may be populated by the trader or by the OATS 10.

The market data feed ID 51 corresponds to a particular data feed (and exchange) configured in OATS 10. It relates all events types 56 having a particular value to the source of the event. The market data feed ID 51 is generated automatically by OATS 10 at configuration. Alternately, a market data feed name (NOT SHOWN) may be provided to describe a particular market exchange represented by the data feed. Examples of market data feed names include “NYSE,” “NASDAQ” and “AMEX”.

The Internet service address 52 may be comprised of sufficient information to establish a TCP/IP or UDP connection to the market data feed 50 on a remote system on the Internet or World-Wide-Web 70. The user ID 53 identifies the licensed user of the market data feed 50. The user authentication 54 may be a token (such as a password) which authenticates the user ID 53 to the remote market data feed 50.

With regard to Security identifiers and symbols 55, the OATS 10 stores data related to individual securities configured by the trader, for use in deciding when and if to execute trades represented by orders entered into OATS 10 by the trader. The security identifier or symbol 55 represents a unique security within a particular market exchange (such as NYSE, NASDAQ and AMEX).

The OATS 10 receives as input from one or more market data feeds 50, market data events 56. The data comprising a market data event 56 is stored in memory 22 as a Market Data Event record 80 (FIG. 3B). A market data event record 80 represents a change in information relating to a market or a security in which the trader is interested in trading.

Referring now to FIG. 3B, a market data event record 80 is comprised of at least the following individual data entities: Market Time 81, Local Time 82, Market Data Feed ID 51, Event Type 56, Status 83, Security Symbol 55, Volume 84, or Price 85.

The market time 81 represents the time according to a particular market exchange. It is used to synchronize operations of all participants which may be in various local time zones. The market time 81 may be an 8 character field, containing the time format HH:MM:SS, in military time. AM times are 00:00:00 to 11:59:59. PM times are 12:00:00 to 23:59:59. The local time 82 is the time according to the computing device 20. Local time 82 may be used for any purpose deemed necessary in the design of OATS 10. For example, the local time 82 is particularly useful for distinguishing events temporally.

The market data feed ID 51 corresponds to a particular data feed 50 (and exchange) configured in OATS 10. It relates all events having a particular value to the source of the event.

The Security Symbol 55 indicates the security to which the event type 56 pertains. It relates the event to a particular security, and relates the event to any order for the same security. The security symbol 55 may be undefined when the event type 56 is not one of {SECURITY_STATUS, SECURITY_VOLUME, SECURITY_BID_PRICE, SECURITY_ASK_PRICE}.

The event type 56 distinguishes various events of interest to OATS 10. The event type 56 comprises at least {MARKET_STATUS, SECURITY_STATUS, MARKET_VOLUME, SECURITY_VOLUME, SECURITY_BID_PRICE, SECURITY_ASK_PRICE}.

The status 83 may have a value of MARKET_STATUS which indicates that the market signified by market ID 51 has either open, closed, halted, or resumed. The status 83 may have a value of SECURITY_STATUS which indicates that the security (identified by its symbol 55), has either halted or resumed trading. The MARKET_STATUS has the values which comprise at least {OPEN, CLOSE, HALT, RESUME}. The SECURITY_STATUS has the values comprise {HALT, RESUME}. When the event type 56 is not MARKET_STATUS or SECURITY_STATUS the status 83 shall be undefined. The value CLOSE indicates that the security has not opened for trading; the value HALT indicates a temporary, intra-day halt on a security; the value OPEN indicates the security is currently trading on an exchange; and the default value of this field is CLOSED, in the absence of information received from market data feeds 50. The status 83 in input to OATS 10 from a market data feed 50, upon receipt of information (a market data event) pertaining to the security identifier or symbol 55.

The volume 84 has a value of MARKET_VOLUME which indicates that the event type 56 contains information on total volume for the market identified by ID 51. Volume 84 also has a value of SECURITY_VOLUME which indicates that the event type 56 contains volume information for the security symbol 55. The security volume indicates the total volume of shares traded in the given security when the security status (status 83) is OPEN or HALT. It is undefined when the security status (status 83) has any other value. The value of this field in input to OATS 10 from a market data feed 50, upon receipt of information (a market data event) pertaining to the security symbol 55.

The price 85 has a value of SECURITY_BID_PRICE which indicates that the inside bid on the security symbol 55 has changed. The price 85 may have a value of SECURITY_ASK_PRICE which indicates that the inside ask on the security symbol 55 has changed.

The value of the SECURITY_BID_PRICE field indicates the inside bid price at which market makers or specialists on the exchange where the security trades are willing to purchase this security identified by the security symbol 55. The value of this field in input to OATS from a market data feed 50, upon receipt of information (a market data event) pertaining to the security symbol 55. The value of the SECURITY_ASK_PRICE field indicates the inside ask price at which market makers or specialists on the exchange where the security trades are willing to sell the security. The value of this field in input to OATS 10 from the market data feed 50, upon receipt of information (a market data event) pertaining to the security symbol 55.

In view of the forgoing, the OATS 10 keeps track of the securities underlying Listed Equity Options using data received from market data feeds 50. Such market data feeds 50 may be purchased from third party vendors, typically for a monthly fee, and although previously delivered via dedicated lines, are usually available over the Internet via the World-Wide-Web 70. The data in these feeds 50 is published in real-time from securities exchanges such as NASDAQ 50a and the NYSE 50b via their respective gateways. The status of such securities can include recent trade prices, published bid and ask prices, reflecting the actual market value, and the status of the entire exchange or a particular security, such as CLOSED, OPEN, or SUSPENDED.

As a result of the processing of these incoming events, the OATS application 100 generates records in its various files, particularly those representing activity logs and system state. In particular, the activity logs are entered into spreadsheets using spreadsheet applications 36. The activity logs are intended to be read not only by OATS 10, but by other software applications available on the computing device 20, such as financial 30, trading 32, or other productivity or utility software 34 for various purposes, including generation of printed reports, profit/loss statements, tax liability calculations, etc. Therefore, the design and format of these log files are constrained in a manner that requires the least amount of effort to enable the importation of the data in these files into other software applications.

### Online Brokerage Account

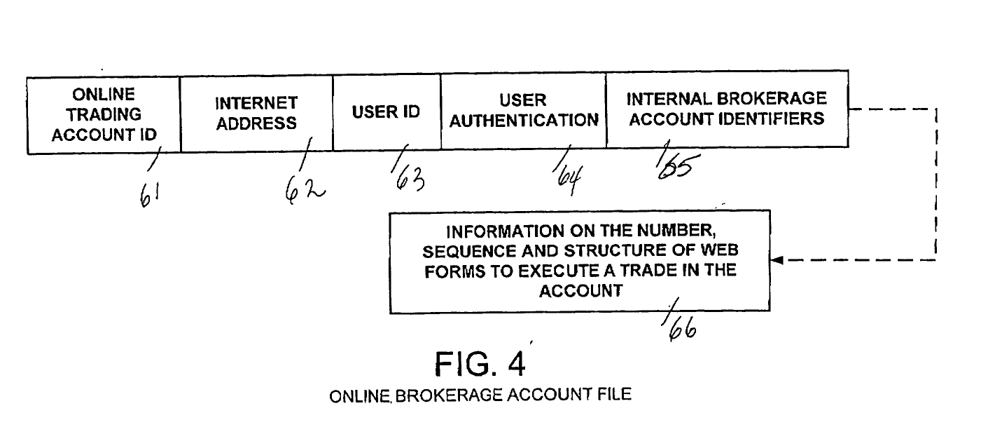

Referring again to FIG. 2, the OATS 10 allows the trader to use multiple online brokerage providers 60a, 60b and 60c, each of which has their own web-based online trading system A, B, C, respectively. If the trader trades with the multiple online brokerage providers 60a, 60b and 60c, an Online Brokerage Account 60 has been established at each such provider. Accordingly, the OATS 10 stores configuration information, in a file (FIG. 4) in memory 22. This information is input by the trader as part of the initial configuration mode 142 for configuring the online brokerage accounts. This information is used to connect to computing device 20 of the OATS 10 to each online brokerage account 60 to execute trades.

Similar to market data feeds 50, online trading accounts 60 (such as without limitation Salomon Smith Barney Access 60a, E*Trade 60b and Other 60c) operate via a high-level protocol known as Hyper Text Transfer Protocol (HTTP), which characterizes the World Wide Web 70. HTTP is built on top of TCP/IP protocol. The trader would access such accounts 60 via a web browser (such as late versions of Netscape and Microsoft Internet Explorer).

These accounts 60 are interactive and transaction oriented. That is, the trader typically transmits some information and the service responds with a new web page (constructed in HTML) reflecting the effect of the user's previous request. This exchange occurs in “near-real-time”, and may involve substantial delays relative to the real-time market data feed 50. Nevertheless, XML may be used in lieu of HTML to construct web pages.

Furthermore, the online trading accounts 60 often include the ability to access multiple distinct brokerage accounts beneficially controlled by the trader. In other words, a single online trading account 60 for a trader at a single provider may provide access to multiple accounts each distinguished by a separate identifier, unique to the particular online trading account 60 in question.

The OATS application 100 accepts and stores, in a file (FIG. 4), all such information as part of its configuration for each online trading account it will access including: online trading account identification 61; Internet address 62; typically including a hostname and/or Internet address and port number; user identification 63; user authentication 64; one or more internal brokerage account identifiers 65; and, information 66 on the number, sequence and structure of web forms required to execute a trade in the associated account. As can be appreciated, a configure GUI for the online trading account file would have the necessary data entry fields to enter the above information. Some of the data entry fields may be populated by the trader or by the OATS 10.

Using the Web Browser and/or HTML Parser/Generator 38, the OATS 10 acts as a proxy on behalf of the trader in executing trades via online brokerage providers. That is, the OATS 100 executes a trade by programmatically performing the exact same manual and web-site navigational operations (as configured by information 66) that would otherwise result if a human trader accessed their online brokerage account 60 at an online brokerage provider via a web browser and effectuated a trade.

Referring now to FIG. 4, the composition of Online Brokerage Account configuration file includes several data field described below.

The Online Brokerage (trading) Account ID 61 is a unique identification within the OATS 10 to distinguish among multiple online accounts. The Online Brokerage (trading) Account ID 61 relates to one or more brokerage account IDs, one or more orders, and a particular web access method, including the type of web browser, number and sequence of web forms to submit. In the preferred embodiment, the Online Brokerage (trading) Account ID 61 is generated automatically by the OATS 10 upon configuration of the account by the trader.

The user ID 63 identifies the licensed user of the online brokerage account 60 and is input by the trader. The user authentication 64 may be a token (such as a password) which authenticates the user ID 63 to the remote online brokerage account 60 and is input by the trader.

Since each trader may have one or more accounts at an online brokerage, each online brokerage account ID 61, may have one or more brokerage account IDs 65 associated with the online brokerage account 60. These IDs shall be determined by the online brokerage account provider, and input by the trader.

The OATS 10 stores information 66 sufficient to act as a proxy for the trader in submitting trade orders via the World-Wide-Web 70 to online brokerage accounts 60 via remote online brokerage providers 60a, 60b, 60c. This information 66 includes at least (1) the path to an appropriate executable or module in the local file system; (2) any invocation parameters; and (3) version information. Such information 66 may be configured by the trader or automatically during installation (initial configuration mode 142). This information 66 further includes the Web Access Method. The web access method includes at least (1) the number of web forms/screens necessary to complete submission of a trade to a particular online brokerage provider; (2) the sequence of said forms/screens; and (3) the field identification and content of each field on each form. This information 66 may be configurable by the trader.

### Security Index/Indices

The OATS 10 accepts as input, via data import or configuration (mode 146 of FIG. 5), one or more security indexes, consisting of an index identifier and a list of one or more security symbols. The OATS 10 accepts security index/indices as input in the form of an external file. Such a file shall be in a format which may be edited by the trader in a word processing application. The OATS 10 limits the selection of particular securities in the configuration mode 146 to be selected only from the set consisting of the union of all securities listed in securities indexes input to OATS.

### OATS Application Operations

Referring now to FIG. 5, the OATS application 100 has two primary modes of operation: (1) User Interactive 140 and (2) Automated Trading 160. These two modes are not mutually exclusive, so OATS 10 will support user interaction independent of and simultaneous to automated trading.

In addition, there are several other less frequent modes of operation: (1) Install/Uninstall 110; (2) Backup/Recover 115; (3) Import/Export Data 120; (4) Integrity Check 125; and, (5) Start/Resume or Stop/Suspend 130. These additional modes can be entered either by User initiation, or automatically in response to some event, including detection of specific types of failure.

With reference to the User Interactive Mode 140, this mode 140 includes the following functions: (1) Configuration of Online Brokerage Accounts 142; (2) Configuration of Market Data Feeds 144; (3) Configuration of Indexes and Securities of Interest 146; (4) All other Configuration; (5) Order Entry, Order Modification, Order Cancellation 148; (6) Data Import/Export 150; and (7) Start/Resume or Stop/Suspend 152.

Regarding the Install/Uninstall Mode 110, this mode 110 is user initiated, either to install or uninstall the OATS application 100. Other than these two situations, the OATS application 100 does not enter this mode.

Regarding Backup/Recovery Mode 115, the OATS application 100 backs up all state and configuration data to files which are not otherwise used by the software. This may be done at the request of the user, or it can be done automatically under the various conditions. For example, a backup should be performed automatically when the application 100 is stopped by the user, provided the OATS first passes an integrity check 125. A single backup should never be overwritten, rather, a series of backups shall be kept, so that in the event the most recent backup was corrupt, the application 100 may fall back to an earlier intact backup. Additionally, a backup may be performed automatically after a recovery from a corrupt or failure state. Furthermore, if the application 100 fails an integrity check 125 on startup, it may automatically recover from the latest uncorrupted backup.

Regarding the Import/Export Data Mode 120, this mode 120 is initiated by the user in order to read in or write out configuration or state information related to pending orders, order execution status, or general configuration.

Regarding the Integrity Check Mode 125, this mode 125 is entered automatically prior to exiting Start Mode or entering Stop mode. The OATS application 100 checks its internal state or configuration for errors, correct any errors which can be corrected, or signal a corrupt state, possibly triggering backup or recovery operations.

Regarding the Start/Resume, Stop/Suspend Mode 130, Mode 130 is automatically initiated by the OATS 10 such as from data received via the market data feeds 50 or when the user performs certain functions. The Start/Resume, Stop/Suspend Mode 152 is initiated by the trader. For example, Start and Stop functions of mode 152 can be entered manually by the trader. However, the Stop function of mode 130 may be automatically initiated due to a serious and unrecoverable error during application execution. Start initializes the process, reading in all necessary saved state and configuration information required to pass an integrity check and allow OATS application 100 to function. The Stop function shuts down the OATS 10, verifies integrity, may perform a backup, and removes all OATS 10 processes from computer memory 22.

Suspend may be initiated by a trader, to suspend operations such as to stop the execution any trades. During suspension in mode 152, Order Entry and Configuration modes 142, 144, 146 and 148 are available, and Market Data updates are processed (but no trades will be executed). Upon resumption, any order still present in the OATS 10, which meets execution criteria, will be executed. Resume and Suspend in mode 130 can be triggered by Market Data Events, depending on the exact nature of the events.

Referring now to the Automated Trading Mode 160, this mode includes the following processes: (1) Trade Order Execution process 162; (2) Suspend/Resume Trading process 164; (3) Market Data Event Dispatching process 166; and (4) Trade Execution Decision process 168.

Once OATS 10 has successfully completed the Start mode and read existing configuration data related to the market data feeds 50 and the online brokerage accounts 60 (FIGS. 3 and 4), a dedicated thread of execution or mode in the OATS application 100 will enter a loop, waiting for, and dispatching market data events 56 as they arrive. Such process is the Market Data Event dispatching process 166. The Market Data Event dispatching process 166 is responsible for opening and maintaining connections to market data feeds 50, and receiving and dispatching events types 56 data received from the market data feeds 50, such as, without limitation, bid/ask price changes, security status or market status. Some of these events types 56 may trigger the trade order execution process 162 after a decision is made via the trade execution decision process 168.

Furthermore, depending on the event type 56 data or the user interactive mode 140, trading may be suspended or resumed via the Suspend/Resume Trading process 164. After the event type 56 data has been evaluated by the trade execution decision mode 168, an order may be processed by the trace order execution process 162. Moreover, the Market Data Event dispatching mode 166 dispatches the event type 56 data so that it is logged into memory 22.

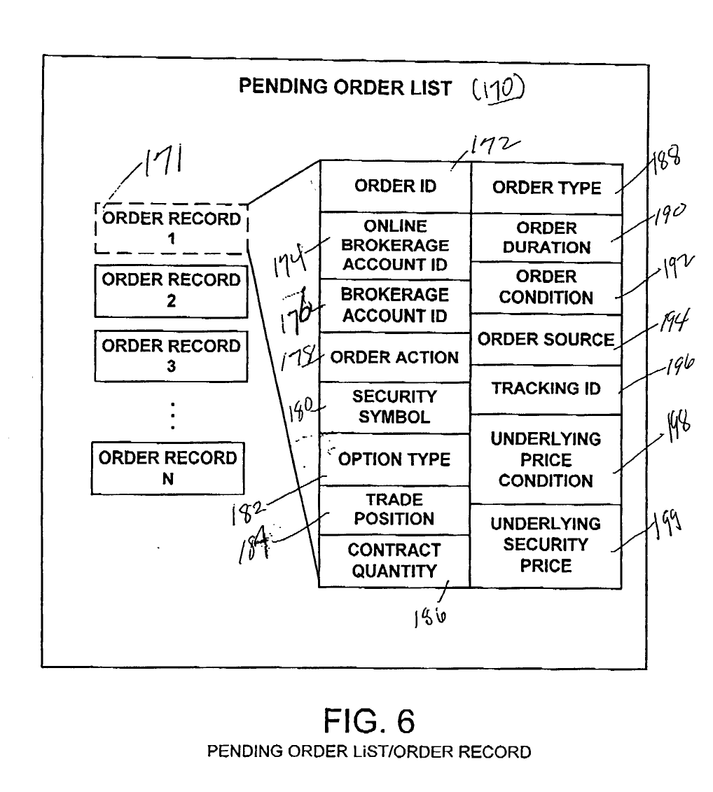

Referring also to FIG. 6, the trade execution decision process 168 determines whether (1) a market data event is a price update for a given security, which is not halted, in a market which is trading; (2) a security has resumed trading (from a HALT); (3) a market has resumed trading (from a HALT); and (4) a market has opened. Thereafter, the trade execution decision process 168 evaluates one or more order records 171 in the pending orders list 170 and decides whether one or more pending orders records 171 should be executed by the trader order execution process 162.

In an exemplary embodiment, each order record 171 includes the following fields: a unique order ID field 172, a unique Online Brokerage Account ID field 174 that represents the user's choice of which online trading account to use; a Brokerage Account ID 176 that is a vendor dependent account identification number within the particular online brokerage service representing the user's choice of which account to attribute the trade to; an Order Action field 178 that indicates the order being a BUY or SELL order; a Security Symbol field 180 that is an exchange dependent symbol signifying a particular option on a particular stock; an Option Type field 182 that indicates whether the option is a PUT or CALL option; a Trade Position field 184 that indicates whether the order is to OPEN or CLOSE a position; a Contract Quantity field 186 that indicates the number of option contracts to buy or sell; an Order Type field 188 that indicates whether the order is a MARKET, LIMIT or STOP order; an Order Duration field 190 indicating whether the order is a DAY order or GTC order; an Order Condition field 192 indicating whether the order is NONE or ALL OR NONE order; an Order Source field 194 indicating whether the order is a SOLICITED or UNSOLICITED order; a Tracking ID field; an Underlying Security Price field 199 that is the price of the underlying security and an Underlying Price Condition field 198 which is the condition (for e.g., greater, greater than or equal, less than, less than or equal or NONE) applied to the value in Underlying Security Price field 199 to determine whether to execute the particular order.

The decision process carried out by trade execution decision process 168 for each order in question, is further based on the underlying price condition 198 in the order record 171, defined on that particular order. The underlying price condition 198 is compared against market event type 56 data in the market data event record 80 regarding the status 83 and current price 85 of the security (identified by security symbol 55). If the price condition 198 is true when the underlying security price 199 is compared to the current price 85 in the event type 56 data, then the trade execution decision process 168 will trigger the trader order execution process 162. It should be noted that since the order records 171 have order durations associated therewith, the OATS application 100 also purges the list of pending orders 170 of expired order records 171.

The trader order execution process 162 will use the online brokerage account ID 174 and the brokerage account ID 178 to access the pre-configured online brokerage account data file (FIG. 4). Thereafter, the trader order execution process 162 retrieves information 66 to access the web access method therein for the relevant online brokerage account in order to execute the option order record 171 on behalf of the trader with the corresponding online brokerage account 60 at the remote brokerage provider (FIG. 2).

More specifically, the process 162 of effecting a trade execution requires the pre-configured information 66 regarding the number, sequence and content of the web pages and/or forms which the user would normally exchange with the Online Brokerage Account web interface. The process 162 uses this information 66 to automatically perform the transactions which would otherwise be performed manually by the trader via the GUI's of the remote online brokerage provider.

With reference to the trade execution decision process 168, the price conditions 198 are defined on the stock underlying the option, not on the option itself. For instance, example orders (which may be displayed on the main GUI), might be expressed as:

Buy 20 contracts of IBM MAY 90 calls IF IBM trades at $90 or less wherein the value “20” is contract quantity 186; the value “IBM May 90” is the security associated with the value contained in security symbol field 180; the value “calls” is the value in option type field 182; the occurrence of the value “$90” is the value contained in Underlying Security Price field 199 and “at $90 or less” is the condition contained in Underlying Price Condition field 198.

Another order example might be expressed as:

Buy 20 contracts of Microsoft (MSFT) May/2001 80 puts IF MSFT trades at $80 or greater

wherein the value “20” represents the contract quantity 186; the value “Microsoft May/2001 80” is the security associated with the value contained in security symbol field 180; the value “puts” is the value in option type field 182; the occurrence of the value “$80” is the value contained in the Underlying Security Price field 199 and “at $80 or greater” is the condition contained in Underlying Price Condition field 198.

In an exemplary embodiment, an order may include additional conditions relating to order execution. An example order may be:

Buy 10 contracts of Intel (INTC) October 30 puts at a limit price of $2.50 if INTC trades at $27.50 or greater

in which case 20 contracts of INTC October 30 puts are only bought if INTC trades at $27.50 or greater AND if the price of an INTC October 30 put is $2.50 or less. Another exemplary order may be:

Buy 10 contracts of GM JULY/2001 50 calls at a limit price of $1.50 if GM trades at $48 or less

in which case 10 contracts of GM JULY/2001 50 calls are bought if GM trades at $48 or less AND if the price of a GM JULY/2001 50 call is $1.50 or less. In cases where an order does not specify a limit price, it may be assumed that the order is to be executed at the market.

In addition to the underlying price condition 198 being true to effect the automatic execution of a trade, other data in the order record 171 is evaluated such as the Order Condition 192.

An order's underlying price relationship (OUPR) is created in a formula and is expressed as

OUPR=R(Pc,Pt)

wherein the R(Pc,Pt) represents the relationship (for e.g., (GT, GTE, LT, LTE or NONE)) between the current underlying inside bid price Pc and the underlying security price 199, herein after referred to as the trigger price Pt. The relationship R(Pc,Pt) is a function of the order price condition 198.

The formula to execute a trade on a given security is expressed as: IF R(Pc,Pt) is TRUE THEN EXECUTE the order wherein Pc represents the current security inside bid/ask price; Pt represents the underlying security trigger price 199. Accordingly, the decision to execute an order varies from one order to another.

The OATS 10 is designed to run continuously unless intentionally stopped by the trader or end user. Additionally, the OATS 10 maintains a store of scheduled trading holidays for each market exchange and determines trading versus non-trading days relative to the local time zone if the computing device 10. Moreover, the OATS 10 can schedule itself, using features of the PC operating system 26, to start automatically not less than one half (½) hour prior to the earliest scheduled start of trading on any scheduled trading day on any market exchange configured. Accordingly, the OATS 10 executes any order automatically when conditions are met without any input from the end-user or trader.

### Order Entry GUI

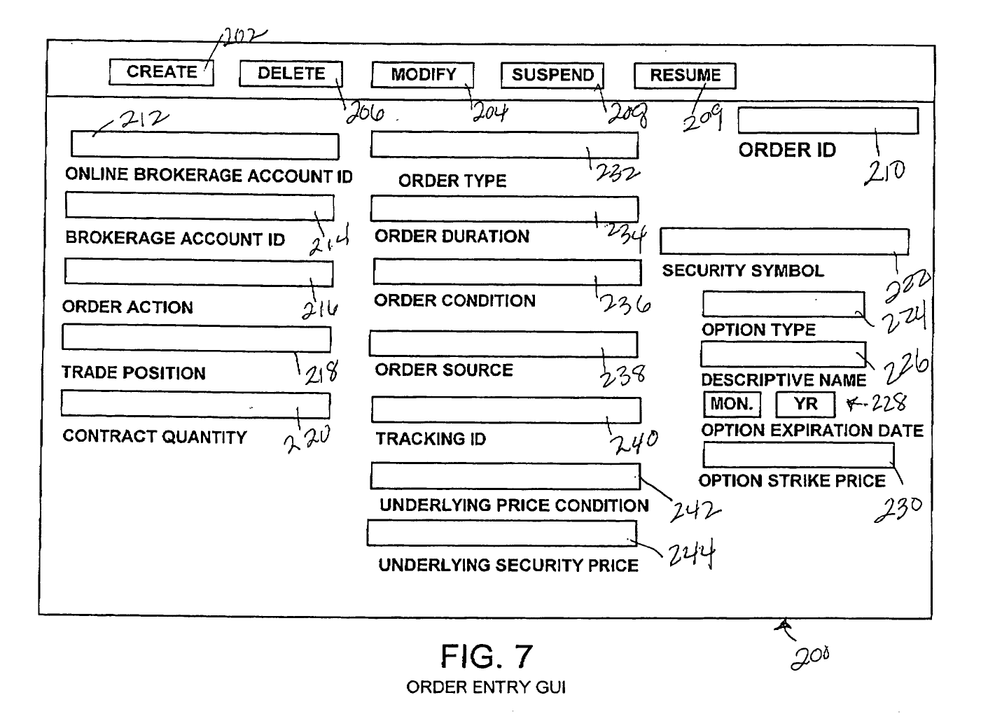

Referring now to FIG. 7, once a trader has entered or has caused to be entered by the OATS 10 the configuration data required in modes 142, 144 and 146, described above, the trader may enter or modify an order via an order entry GUI 200. Once a new order is entered and validated, it appears on the list of pending orders (FIG. 6) displayed in the main GUI. Additionally, alert, error, or status information may be displayed in the main screen.

Referring also to FIG. 6, each order record 171 may be accessed via a hypertext link from the list of pending orders as displayed on the main GUI. Selection of the hypertext link of an order would automatically navigate the system to display the order entry GUI 200 having the data entry fields populated with the order record data, described below.

Alternately, the orders may be read into the OATS 10 in bulk from a file. The trader may also modify configuration of market data feeds 50 and online brokerage accounts 60 via one or more configuration GUIs (NOT SHOWN).

The array of operations that an end-user may manually perform on an order is: (1) Create Order upon selecting button 202, (2) Modify Order upon selecting button 204; (3) Delete Order up selecting button 206; (4) Suspend Order upon selecting button 208; and, (5) Resume Order upon selecting button 209.

The trader may choose at any time to input (create) a completely new order record 171 to the list of pending orders 170. An exemplary, order entry GUI 200 is shown. The order entry GUI 200 includes a data entry Order ID field 210; a data entry Online Brokerage Account ID field 212 (a unique ID within the OATS online brokerage accounts representing the end-user's choice of which online trading account, of a remote online brokerage provider, to use for the order); a data entry Brokerage Account ID field 214 (a vendor dependent account identification number within the particular online brokerage service, representing the end-user's choice of which account to attribute the trade to); a data entry Order Action field 216; and a data entry Contract Quantity field 220 (the number of contracts to buy or sell).

The ID entered in the data entry Online Brokerage Account ID field 212 has been preestablished in OATS via the configuration mode 142 of the online brokerage accounts. Therefore, when the ID in field 212 is read, the file (FIG. 4) related to such ID is accessed to retrieve the information 66 necessary to act as the traders proxy to carry out the trade with the online brokerage provider identified.

The order entry GUI 200 further includes a data entry Security Symbol field 222; a data entry Option Type field 224 (PUT or CALL); a data entry descriptive name field 226; a data entry Option Expiration Date field 228, including month and year; and, a data entry Option Strike Price field 230 (OATS determines from the option symbol).

The order entry GUI 200 further includes a data entry Order Type field 232 (MARKET or LIMIT or STOP); a data entry Order Duration field 234 (DAY or GTC); a data entry Order Condition field 236 (NONE or ALL OR NONE); a data entry Order Source field 238 (SOLICITED or UNSOLICITED); a data entry Underlying Price Condition field 242 (GT or GTE or LT or LTE or NONE); and, a data entry Underlying Security Price field 244 (a trigger price related to the condition above on the underlying security). Moreover, the order entry GUI 200 includes a Trade Position data entry field 218 and a Tracking ID data entry field 240.

It should be noted that the Security Symbol for field 222 can determine the following additional information, which may be contained in the order record 171 after being automatically determined by OATS 10: (1) Option Type for field 224; (2) Underlying Security Symbol and/or descriptive name for field 226; (3) Option Expiration Date, including month and year for field 228; (4) Option Strike Price for field 230.

The process of creating an order may be verified for integrity by OATS application 100 on a field-by-field basis as entered and/or in whole after the user indicates to OATS the entered order is to be committed to the pending order list 170. It is desirable to include some functionality to enable the trader to optionally create a new order based on data from another pending or executed order. This can save significant entry time if particular types of trades are commonplace.

Once an Order is input into the OATS order pending list 170, it may be modified by the end-user at any time prior to execution by selecting the delete button 206. The user selects the order using the main GUI. Once the order entry GUI 200 for the selected order data is displayed the populated data entry field can be modified.

Preferably, once the trader modifies or begins to modify the data in the data entry fields, the OATS application 100 automatically suspends (mode 130) processing of that particular order record 171, until modification is completed successfully, aborted, or the order is deleted (in which case no further processing will occur).

Once an order record 171 is input into the OATS pending order list 170, it may be deleted by the trader at any time prior to execution. The trader selects the order record 171 using the main GUI. The order entry GUI 200 may be displayed and choose to the delete button 204. Once the selected the order record 171, the OATS application 100 automatically suspends processing of that particular order, until the order record 171 is deleted (in which case no further processing will occur).

Preferably, once a trader has selected the order record 171 from the list of pending orders 170, such selection is indicative that they do not wish the order record 171 executed as is. Accordingly, the selected order record 171 is automatically suspended.

The end-user may wish to stop OATS 10 from automatically executing a particular pending order record 171, but stop short of deleting that order record 171 from the pending order list 170, for any number of reasons. Accordingly, the trader can select the suspend button 208. Alternately, the trader can select any pending order records 171 via the main GUI, and using either a keyboard shortcut (key-combination) or popup menu, choose to suspend a pending order or resume a previously suspended order. Resume is the converse of Suspend, and will function in the same way or by using the Resume button 209 or other key-combination.

### Order Record

In view of the above, the OATS 10 provides a means to input orders by the trader. The data record comprising an order is stored in memory 22 and in file(s) as an order record 171. However, the order record 171 may be one of several order records 171 for the trader. Each order record 171 represents an individual trade of an option security which the trader wished executed under specific conditions. The order record 171 relates to a particular security identified by its security symbol 180, brokerage account ID 176, online brokerage account ID 174, and market where the security is traded. Order records 171 may be input by the end-user via the GUI, or in bulk via data import from an external file.

The order ID 172 is a unique identifier for a particular order recorded in the OATS 10. The order ID 172 is preferably automatically generated by OATS 10. The online brokerage account ID 174 is a unique identifier of a particular online brokerage account 60 configured for use in the OATS 10. The online brokerage account ID 174 preferably is automatically generated by OATS 10, when the online brokerage account 60 is configured, and relates a particular order to the online brokerage account 60 used to execute that order. The brokerage account ID 176 identifies a particular brokerage account available through a particular online brokerage account 60 configured in the OATS 10. The brokerage account ID 176 can be input by the trader, when the online brokerage account is configured. It relates a particular order to the brokerage account used to execute that order. The order action 178 indicates the type of trade, BUY or SELL and is input by the trader as part of an order. Its range of possible values consists of {BUY, SELL}.

The security symbol 180 describes an option security uniquely on market exchange(s) and is input by the trader as part of an order. Option symbols implicitly contain additional information regarding the underlying security symbol and name, the option type, expiration date, and strike price. The range of possible values are dictated by the various trading exchange rules for composing such symbols, and further restricted to the class of Listed Equity Options, comprising one or more indexes, defined by the end-user as part of configuration.

The option type 182 indicates the particular rights associated with that option and is input by the trader as part of an order. Its range of possible values consists of {PUT, CALL}. The trade position 184 indicates whether the trader will remain holding these securities after the trade and is input by the trader as part of an order. Its range of possible values consists of {OPEN, CLOSE}. OPEN indicate securities will remain in the account of the trader, while CLOSE indicates that the securities will not remain.

The contract quantity 186 indicates how many contracts the trader wishes to buy or sell and is input by the end-user as part of an order. The minimum possible value is 1. The maximum may support quantities up to 10,000 at a minimum.

The Order Type 188 indicates a price condition on the amount the trader is willing to pay or accept for a particular contract and is input by the trader as part of an order. The range of possible values consists of {MARKET, LIMIT, STOP}. It relates to the current price of the option security, in the case of LIMIT and STOP. The Order Duration 190 indicates how long the order shall remain active in the broker's system if it is not filled immediately and is input by the trader as part of an order. The range of possible values consists of {DAY, GTC}. DAY indicates until the close of trading on the day the order was entered; and GTC indicates “good until cancelled”. The default value may be DAY, prior to trader input. The Order Condition 192 indicates the trader's preference for partial executions and is input by the end-user as part of an order. The range of possible values consists of {NONE, ALLORNONE}. NONE indicates no preference; and ALLORNONE indicates that the broker should not fill the order unless they will fill the entire lot (contract quantity 186). The default value may be NONE, prior to trader input.

The Order Source 194 indicates whether the order was initiated entirely at discretion of the trader, or whether a broker suggested the trade and is input by the trader as part of an order. Its range of possible values consists of {SOLICITED, UNSOLICITED}. SOLICITED indicates a broker suggested the trade; UNSOLICITED indicates no broker was involved; and the default value may be UNSOLICITED, prior to trader input.

The Tracking ID 196 is an identification tag which may be received by OATS 10 after the trade has been executed by OATS 10 (submitted to the online brokerage account). A special value is reserved to indicate NULL if such a tag is not provided in response to a successful order submission. If present, the tracking ID 196 may be displayed as part of the executed order status or output as part of an audit record.

The underlying price condition 198 represents a relationship between the underlying security price 199 and the order and is input by the trader as part of an order. The range of possible values may includes {GT, GTE, LT, LTE, NONE}. The default value may be NONE, prior to trader input; GT indicates a relationship of “greater than”; GTE indicates a relationship of “greater than or equal to”; LT indicates a relationship of “less than”; and LTE indicates a relationship of “less than or equal to”. If the value is not NONE, then the underlying price condition 198 shall be a factor in the execution decision.

The underlying security price 199 is relevant to the Underlying Price Condition 198. If the Underlying Price Condition 198 is NONE, this field shall have no effect on OATS 10, and a special reserved value indicating NULL is stored in this field.

### Audit Record

The OATS 10 generates an audit record to an external log file when (1) a new order record 171 is entered on the list of pending orders 171 (and has been validated); (2) an existing order 171 is changed and re-validated; and, (3) the status of the order record 171 has changed.

### Automated Trading Logic

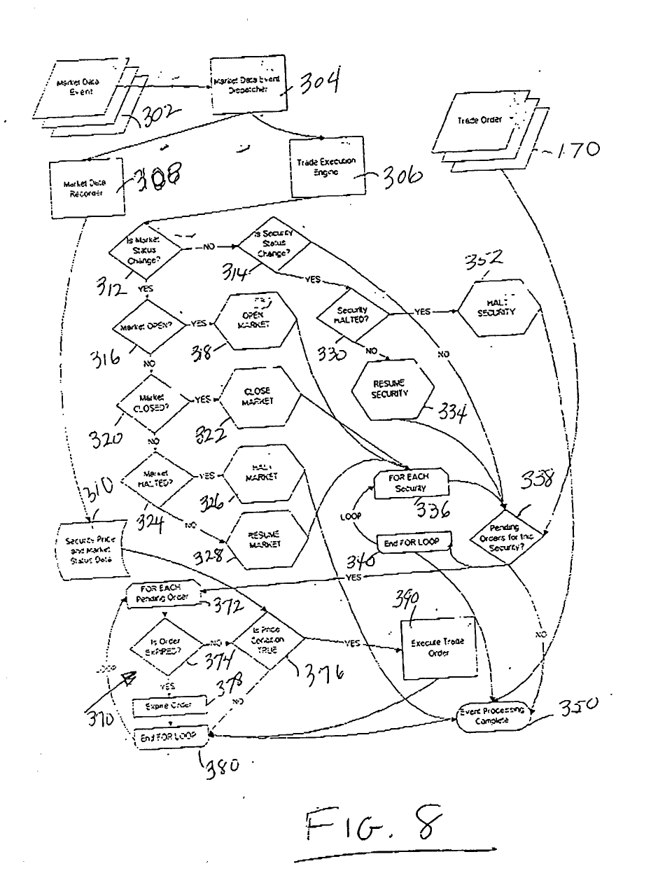

With reference to FIG. 8, the general flowchart of the logic or automated trading mode 160 is shown. The flowchart begins at Step 302 where there is a Market Data Event Input from the market data feeds 50. The arrival and input of such Market Data Event Types 56 (FIG. 3A, FIG. 3B) may be asynchronous with respect to other functions. Step 302 is followed by Step 304 where the Market Data Event Type 56 is monitored by a Market Data Event Dispatch process 166 (FIG. 5)

The Market Data Event Dispatch process 166, as described above, is a dedicated process or thread which monitors connected market data feeds 50, read arriving market data event types 56, and dispatches them to other OATS processes or threads. The function of such Market Data Event Dispatch process 166 is a loop consisting of waiting on one or more input sources, reading market data events, populating new market data event records 80 with this information, and sending such events to other OATS processes/threads. Accordingly, Step 304 is followed by Steps 306 and 308.

With reference to Step 308, Step 308 is a Market Data Event Type Recording process to develop record 80 (FIG. 3B). The Market Data Event Type 56 information detected at Step 304 is recorded by an OATS application 100 in an internal database representing OATS state at Step 310. This information persists between OATS runtimes in one or more files stored on the PC disk.

Market Data Event Information is retained by OATS in memory 22 and files, representing OATS state. More specifically, for each market data feed 50, corresponding to a particular market record 80, stores the last state (Status) indicator received from the corresponding market feed 50, which shall be a value selected from (OPEN, CLOSE, HALT). For each security symbol monitored, corresponding to a particular market feed 50, the OATS application 100 stores the last status 83 for that security, which shall be a value selected from (OPEN, CLOSE, HALT). For each market data feed 50, the OATS application 100 stores the last volume 84 received from the corresponding market data feed 50. For each security symbol 55 monitored, OATS application 100 stores the last volume received from the corresponding market feed, for that security. For each security monitored, corresponding to a particular market, OATS application 100 stores the last inside bid or ask price 85 received from the corresponding market feed, for that security.

Step 310 is followed by determination step 376 for determining whether a price condition is TRUE via the trade execution decision process 168, described above in relation to FIG. 5. If the condition is TRUE and the decision is “YES,” Step 310 is followed by Step 390 where a trade order record 171 is executed by the trader order execution process 162.

Referring now to Step 306, the trade execution engine performs other event type processing. After storing the market event type 56 in the record 80, OATS application 100 evaluates the market data event type 56 against the list of all pending orders 170 (such orders having a status of PENDING).

Step 312 is a decision step to determine a Market Status Change from the MARKET_STATUS. If the decision at Step 312 is “NO” indicating no change has occurred, then step 312 is followed by Step 314. However, if the decision at Step 312 is “YES” indicating a change has occurred, then Step 312 is followed by Step 316.

Step 316 is a decision step for determining whether the market status is OPEN. If a market status event indicates a market is OPEN (“YES”) at Step 316, Step 316 is followed by Step 318. Step 318 performs any processing as the result of and OPEN market status. Step 318 is followed by Step 336 which determines a list of all securities traded on the indicated market. Step 336 is followed by Step 338 where a determination is made where there is at least one order pending in the order list 170 for a security. At Step 338, if the determination is “YES” and an order is pending for the security, Step 338 is followed by an order purging process 370.

Referring now to the order expiring process 370, when processing one or more order(s), Step 338 is followed by Step 372 of the order purging process 370 which begins an order purging process loop for the one or more order(s). Step 372 is followed by Step 374, a determination step to determine whether the order duration of the order record 171 is expired. If the determination at Step 372 is “YES,” the order record is deleted and not processed at Step 378. Step 380 either returns to Step 372 if there are more order records or is followed by Step 350 where the event processing is complete.

On the other hand if the determination at Step 374 is “NO,” then Step 374 is followed by Step 376. Step 376 is the decision step regarding whether the Price Condition is TRUE. The decision is performed by the trade execution decision process 168 described above. If the determination is “YES,” at Step 376, then Step 376 is followed by Step 390 where the trade order is executed in accordance with the trade order execution process 162, described above. Upon completion of Step 390 for the order, Step 390 is followed by Step 380.

However, if the determination is “NO,” at Step 376, then Step 376 is followed by Step 380.

If the order is expired, the order is not executed. An order is considered expired if the Order Duration has a value DAY, and either the market status is CLOSE or the timestamp on the order is not the current day. Processing of the order is terminated, and the order may be deleted or purged from the OATS 10.

The OATS application 100 processes each security in the same manner as processing for a security price update with the exception that event processing continues for each security, once processing is complete for the previous security.

Returning again to Step 316, if the decision at Step 316 indicates the market is not OPENED and the determination is “NO”, Step 316 is followed by Step 320 which is a decision step to determine whether the Market Status is CLOSED. If a market status indicates a market is CLOSED and the determination is “YES,” then Step 320 is followed by Step 322 where the OATS application 100 performs the appropriate processing for a CLOSED market status. Step 322 is followed by Step 336 previously described. For each security on this list, the OATS application 100 processes each security in the same manner as processing for a security price update, with the exceptions that (1) event processing continues for each security, once processing is complete for the previous security; and, (2) only orders which are expired are processed, and such processing consists of only deleting the orders (Step 378).

If the decision at Step 320 determines that the Market is not CLOSED and the determination is “NO,” then Step 320 is followed by Step 324, a decisions step to determine if the Market is HALTED. If the market is HALTED, Step 324 is followed by Step 326. If the market status event indicates a market is HALTED, the OATS application 100 performs any appropriate processing at Step 326. Step 326 is followed by Step 350 where the processing terminates for that event.

On the other hand, if the Market Status is not HALTED and the determination is “NO,” Step 324 is followed by Step 328 and the Market Status is RESUME. Step 328 performs the appropriate processing and is followed by Step 336, previously described. For each security on this list at Step 336, the OATS application 100 processes each security in the same manner as processing for a security price update, with the exception that event processing continues for each security, once processing is complete for the previous security.

If there are No Securities with orders pending in the list of pending orders 170, the market data event shall terminate at Step 350. In other words, the END of LOOP condition at Step 340 terminates the event processing at Step 350.

Referring again to Step 314, Step 314 is a determination step to determine whether there is a Security Status Change. The OATS application 100 distinguishes a security status change from among Market Data Events. If the determination at Step 314 is “YES,” then Step 314 is followed by Step 330. Step 330 is a determination step regarding whether the Security Status is HALTED. If the security status event indicates a security is HALTED and the determination is “YES,” then Step 330 is followed by Step 352 where the OATS application 100 performs any processing appropriate. Step 352 is followed by Step 350 where processing terminates for that event.

However, if the determination is “NO,” at Step 330, then the Security Status is RESUME and the OATS application 100 performs any processing appropriate at Step 334. Step 334 is followed by Step 336, described above. For each order on this list, the OATS application 100 processes each order in the same manner as processing for a security price update. If there are No Orders for a security, the processing for that event is terminated at Step 350.

Regarding a Security Price Change, the OATS application 100 distinguishes a security price change from among the Market Data Events. A security price change shall be denoted by a market data event type of SECURITY_BID_PRICE or SECURITY_ASK_PRICE. With respect to the Security Price Change Processing, the OATS application 100 responds to a security price change by obtaining a list of pending orders for the corresponding security from the list of pending orders 170.

### Order Execution Summary

The execution of an order is Web-based and is executed through a web-based online brokerage account 60 of the trader. When an order (order record 171) is executed, the OATS 10 selects the Online Brokerage Account 60 indicated by the brokerage account ID 176. The OATS 10 uses the web browser or HTML parser/generator 38 indicated in the configuration information 65 of the Online Brokerage Account 60. Thereafter, the OATS 10 automatically and electronically completes the associated fields in each web form, in the sequence indicated in the configuration using the information 66 without human intervention or interaction.

The OATS 10 obtains the status codes returned by the web service, and update the order to reflect either SUCCESS or FAILURE. A SUCCESS indicates when the order has been accepted by the online account 60. Upon SUCCESS, the order status shall be updated from PENDING to EXECUTED. Furthermore, the OATS 10 obtains, if provided, a tracking code returned by the web service, and update the order to reflect such tracking code.

While the description herein is directed to equity derivatives, the OATS can encompass other types of financial instruments. For example, the principles described above may be applied to trading in the Futures and Commodities markets since the trading mechanism in those markets are similar to that of equity options. An example of commodity orders using the techniques of the present invention may be:

Buy 5 GOLD June 2002 contracts IF the price of gold is $300 or greater

Buy 10 Sweet Crude July 2002 contracts IF the of sweet crude is $28.50 a barrel or greater

Furthermore, while the OATS executes a trade based on a particular price condition, the OATS can be configured to execute an order based on other the value of other attributes associated with the underlying security including, by way of non-limiting example, trading volume and volatility.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A method of automated options trading on behalf of a trader comprising the steps of:
tracking current market prices for equity securities;
determining when a predetermined price condition related to an underlying security price and a current market price of a security is fulfilled; and,
automatically executing a trade of a corresponding predefined option order pertaining to the security.

2. The method according to claim 1, wherein the executing step includes the steps of:
acting as a proxy on behalf of the trader in executing the trade via an online brokerage account established through an online brokerage provider; and,
programmatically performing those operations that would result if the trader accessed the online brokerage account via a web browser.

3. The method of according to claim 1, wherein the tracking step comprises the steps of:
receiving, in real-time, a market data feed communicating the current market prices for the equity securities.

4. The method of according to claim 1, further comprising the step of:
repeating the determining step and the executing step for each equity security having a predefined option order in a list of pending orders.

5. The method according to claim 1, wherein the executing step comprises the step of:
retrieving a corresponding web access method for an online brokerage account established through a predefined online brokerage provider in order to execute the option order on behalf of the trader with the predefined online brokerage provider.

6. The method according to claim 1, wherein the step of executing includes the step of buying a predetermine amount of call options related to the equity security.

7. The method according to claim 1, wherein the step of executing includes the step of buying a predetermined amount of put options related to the equity security.

8. The method according to claim 1, further comprising the steps of:
prior to the determining step, determining whether the corresponding predefined option order is expired; and,
if the corresponding predefined option order is expired, expiring the order.

9. The method according to claim 1, wherein the tracking step comprises the steps of receiving, in real-time, security bid prices on at least one market data feed.

10. The method according to claim 1, wherein the tracking step comprises the steps of receiving, in real-time, security ask prices on at least one market data feed.

11. The method according to claim 1, further comprising, prior to the executing step, the steps of:
pre-configuring information regarding a number, sequence and content of web pages to effectuate a trade with an online brokerage provider;
pre-configuring information regarding at least one online brokerage account with the online brokerage provider; and
defining an underlying price condition and a relationship with the underlying security price with regard to the current market price of the equity security.

12. An options automated trading system comprising:
means for tracking current market prices for equity securities;
means for determining when a predetermined price condition related to an underlying security price and a current market price of a security is fulfilled; and,
means for automatically executing a trade of a corresponding predefined option order pertaining to the security.

13. The system according to claim 12, wherein the executing means comprises:
means for acting as a proxy on behalf of the trader in executing the trade via an online brokerage account established through an online brokerage provider; and,
means for performing those operations that would result if the trader accessed the online brokerage account via a web browser.

14. The system of according to claim 12, wherein the tracking means comprises:
means for receiving, in real-time, a market data feed communicating the current market prices for the equity securities.

15. The system according to claim 12, wherein the executing means comprises:
means for retrieving a corresponding web access method for an online brokerage account established through a predefined online brokerage provider in order to execute the option order on behalf of the trader with the predefined online brokerage provider.

16. The system according to claim 12, wherein the trade includes buying a predetermine amount of call options related to the equity security.

17. The system according to claim 12, wherein the trade includes buying a predetermined amount of put options related to the equity security.

18. The system according to claim 12, further comprising the steps of means for purging expired option order.

19. The system according to claim 12, further comprising:
means for pre-configuring information regarding a number, sequence and content of web pages to effectuate the trade with an online brokerage provider;
means for pre-configuring information regarding at least one online brokerage account with the online brokerage provider; and
means for defining an underlying price condition and a relationship with the underlying security price with regard to the current market price of the equity security.

20. An automated options trading system (OATS) comprising the steps of:
tracking current market prices for given United States (US) equity securities; and
executing a trade of a corresponding predefined option order, pertaining to one of the securities, based solely on the price of the one security.

21. A method of trading a derivative security based on an underlying security having an attribute, comprising the steps of:
receiving a condition associated with said attribute;
tracking a value of said attribute of said underlying security;
determining when said value of said attribute meets said condition associated with said attribute; and,
automatically executing a trade in said derivative security.

22. The method of claim 21, wherein said attribute is selected from the group including price, trading volume and volatility.
